(19) United States
(12) Patent Application Publication
(10) Pub. No.: US 2012/0299354 A1
(43) Pub. Date: Nov. 29, 2012

(54) RELEASE MECHANISM FOR A RECLINING SEAT ASSEMBLY

(75) Inventors: Matthias Zimmermann, Munich (DE); Vaibhav Tonge, Pune (IN)

(73) Assignee: LEAR CORPORATION, Southfield, MI (US)

(21) Appl. No.: 13/346,126

(22) Filed: Jan. 9, 2012

(30) Foreign Application Priority Data
May 25, 2011 (DE) 102011076422.4

(51) Int. Cl. B60N 2/22; A47C 1/024

(52) U.S. Cl. 297/354.12

(57) ABSTRACT

A seat assembly is provided that includes a seat bottom and a seat back supported for movement relative to the seat bottom. The seat assembly also includes a support member that extends from the seat back. A release mechanism is supported on the seat back for rotation about the support member, wherein rotation of the release mechanism is adapted to release the seat back for movement relative to the seat bottom.

### CROSS-REFERENCE TO RELATED APPLICATIONS

This application claims priority from German Patent Application No. 102011076422.4, filed May 25, 2011. The disclosure of the application is incorporated herein by reference.

### BACKGROUND OF THE INVENTION

This invention relates in general to seat assemblies, such as can be used in automobiles and other transportation vehicles. In particular, this invention relates to a release mechanism for a reclining seat assembly that is easily accessible to a passenger and that is integrated into the seat assembly in a simple and cost effective manner.

Seat assemblies are commonly used to support passengers in automobiles or other transportation vehicles. Vehicles typically include multiple rows of seats, such as a front row of seats and a rear row of seats. In vehicles where the rear row of seats are not positioned adjacent a door (such as a two-door vehicle), it is common for at least one of the front seats to be a reclining seat assembly. A typical reclining seat assembly includes a seat bottom and a seat back that is pivotally supported to the seat bottom by an adjustable seat frame. As is well known in the art, the seat back of the reclining seat assembly can be pivoted forwardly relative to the seat bottom, thereby facilitating access to and from the rear row of seats.

Typically, a reclining mechanism is provided on the seat frame for normally securing the seat back in a fixed, upright position relative to the seat bottom, while selectively allowing pivoting movement of the seat back relative to the seat bottom. The reclining mechanism is frequently disposed between the seat bottom and the seat back near a lower portion of the seat assembly. A release mechanism is provided on the seat assembly for manual operation of the reclining mechanism. When access to the second row of seats is desired, a passenger actuates the release mechanism, allowing the seat back to be pivoted relative to the seat bottom as described above.

One known release mechanism includes a release lever that is pivotally mounted directly to the reclining mechanism. The reclining mechanism can be operated by manually pivoting the release lever. However, the release lever in this configuration is not easily accessible to a passenger standing outside of the vehicle. Also, such a release lever can be somewhat difficult to operate because the reclining mechanism is typically mounted near a lower portion of the seat assembly. Another known release mechanism includes a release lever that is mounted near an upper portion of the seat back, along an outwardly facing side thereof. A linkage extends between the release lever and the reclining mechanism such that the reclining mechanism can be operated by lifting the release lever. However, such a release lever extends through an opening in the seat back that is specially provided for the release lever and, as a result, typically includes a mounting base and decorative cover that increase the cost and complexity of the seat assembly.

Thus, although known release mechanisms function in an acceptable manner, it would be desirable to provide a release mechanism for a reclining seat assembly that is easily accessible to a passenger and that is integrated into the seat assembly in a simple and cost effective manner.

### SUMMARY OF THE INVENTION

This invention relates to a seat assembly that includes a seat bottom and a seat back supported for movement relative to the seat bottom. The seat assembly also includes a support member that extends from the seat back. A release mechanism is supported on the seat back for rotation about the support member, wherein rotation of the release mechanism is adapted to release the seat back for movement relative to the seat bottom.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a schematic side elevational view of a vehicle including a reclining seat assembly in accordance with this invention.

FIG. 2 is an enlarged perspective view of the reclining seat assembly illustrated in FIG. 1 showing a release mechanism in accordance with this invention.

FIG. 3 is a further enlarged perspective view of a portion of the reclining seat assembly and the release mechanism illustrated in FIG. 2.

FIG. 4 is a perspective view of the release mechanism illustrated in FIG. 3 shown prior to being mounted to the reclining seat assembly.

FIG. 5 is an exploded perspective view of the release mechanism illustrated in FIG. 4.

### DETAILED DESCRIPTION OF THE PREFERRED EMBODIMENT

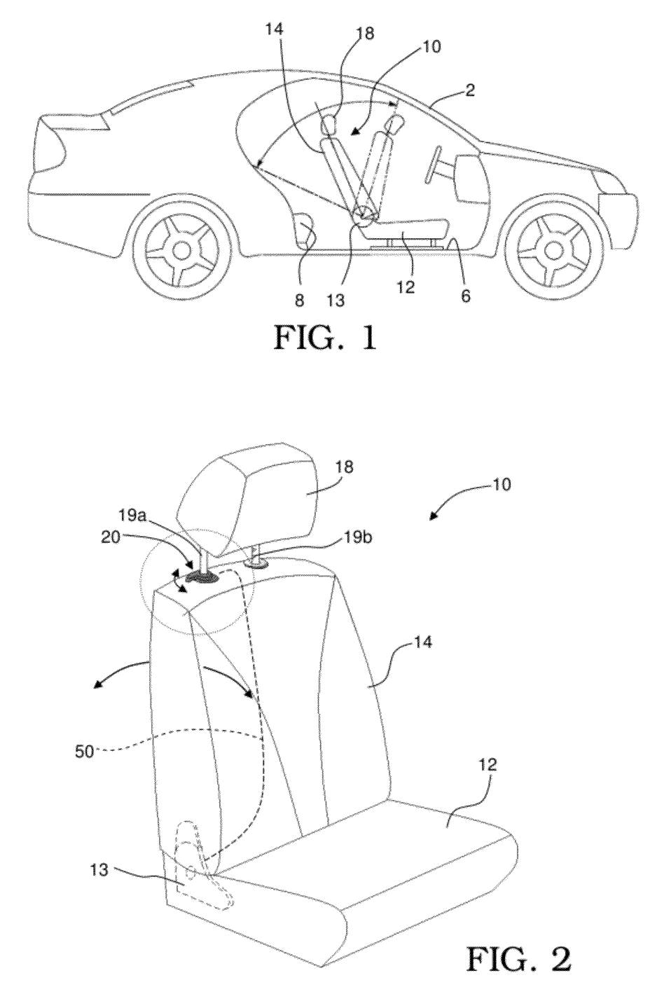

Referring now to the drawings, there is illustrated in FIG. 1 a vehicle 2 that includes a reclining seat assembly, indicated generally at 10, in accordance with this invention. As shown, the reclining seat assembly 10 is disposed within a passenger compartment 4 of the vehicle 2 and supported on a floor 6 thereof. The illustrated vehicle 2 includes a first or front row of seats as indicated by the reclining seat assembly 10 and a second or back row of seats 8 (partially shown). However, the vehicle 2 may have any number or configuration of seats, and the reclining seat assembly 10 can be any seat within the passenger compartment 4. It should also be appreciated that the reclining seat assembly 10 may be used in any desired environment and for any desired purpose.

The illustrated seat assembly 10 includes a seat bottom 12 that is supported on the floor 6 of the passenger compartment 4. The seat bottom 12 can be secured to the floor 6 in any manner such as, for example, by a pair of conventional seat track assemblies or the like. A seat back 14 is pivotally supported on the seat bottom 12 by an adjustable seat frame (not shown). A reclining mechanism 13 is provided for normally securing the seat back 14 in a fixed, upright position relative to the seat bottom 12. The reclining mechanism 13 is, in large measure, conventional in the art and facilitates selective pivoting movement of the seat back 14 relative to the seat bottom 12 in the manner explained in detail below. The illustrated reclining mechanism 13 is disposed between the seat bottom 12 and the seat back 14 near a lower portion of the seat assembly 10. The seat assembly 10 is not limited to the illustrated embodiment, but may be otherwise configured as any pivotally adjustable support structure.

The reclining mechanism 13 allows the seat back 14 to pivot in both fore and aft directions within the passenger compartment 4, as shown by the dotted lines in FIG. 1. For example, the seat back 14 can be pivoted to a folded position (i.e. in the fore direction) to facilitate access to the second row of seats 8. Alternatively, the seat back 14 can be pivoted to a reclined position (i.e. in the aft direction) to provide comfort for a passenger seated thereon. The seat back 14 may also be pivotably adjusted to any position between the folded position and the reclined position to otherwise accommodate passengers of varying sizes and heights.

The illustrated seat assembly 10 also includes a head restraint 18 that is attached to the seat back 14 and extends upwardly therefrom. The head restraint 18 is, in large measure, conventional in the art and is adapted to support the head of a passenger (not shown), such as when resting or during a collision, for example. The head restraint 18 may define any structure that extends outwardly from the seat back 14, including but not limited to an arm rest or the like. The illustrated head restraint 18 is supported on the seat back 14 by a pair of support members 19a and 19b (see FIG. 2), as will be further explained below. The support members 19a, 19b can be any elongated members, such as rods or posts, which extend outwardly from the seat back 14. It should be appreciated, however, that the head restraint 18 can be attached to the seat back 14 in any manner.

Referring now to FIG. 2, the seat assembly 10 includes a release mechanism, indicated generally at 20, in accordance with this invention. The release mechanism 20 is configured to operate the reclining mechanism 13 or otherwise unlock the seat back 14 for pivoting movement relative to the seat bottom 12, as indicated by the arrows in FIG. 2. To accomplish this, a linkage 50 extends from the release mechanism 20 to the reclining mechanism 13, as will be further explained below. Although the release mechanism 20 is described and illustrated in the context of seat assemblies, it should be appreciated that the release mechanism 20 may be used in any desired environment and for any desired purpose.

In the illustrated embodiment, a portion of the release mechanism 20 extends from an opening formed in an external surface of the seat back 14 through which the support member 19a also extends, as will be explained below. This configuration allows the release mechanism 20 to be incorporated into the seat assembly 10 without the need for additional openings to be formed therein. Thus, a single seat design can be adapted for use in various vehicle applications (e.g. with or without a release mechanism). In addition, this configuration allows the release mechanism 20 to be mounted to an upper portion of the seat back 14 near an outwardly facing side of the seat assembly 10. As such, the release mechanism 20 is easily accessible to a passenger standing outside of the vehicle 2. It should also be appreciated that the seat assembly 10 may include additional release mechanisms, but is not necessary.

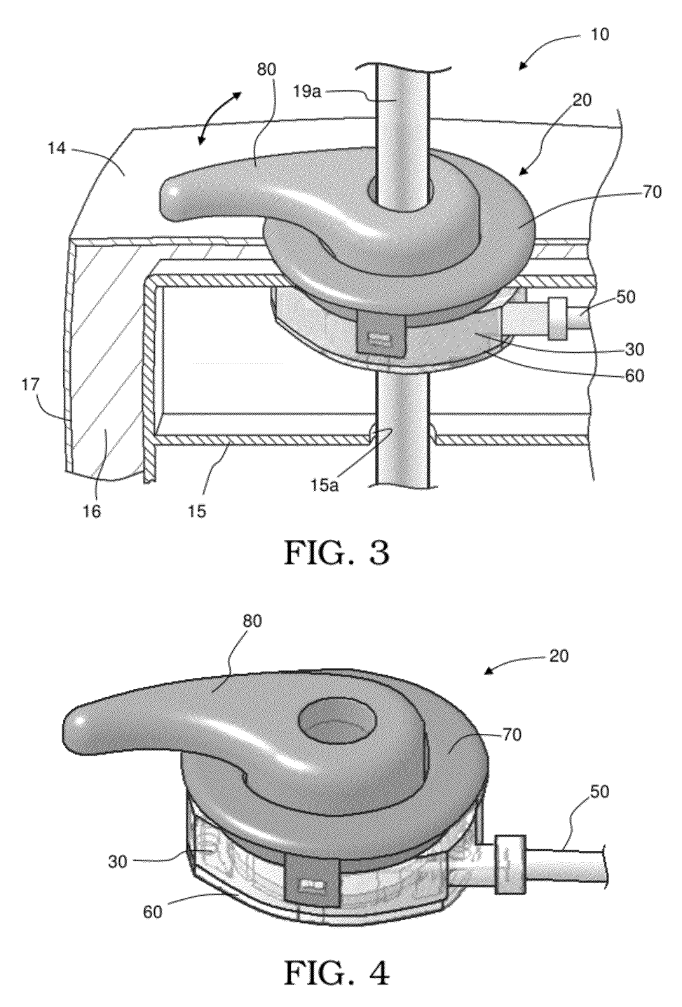

Referring now to FIG. 3, the illustrated seat back 14 includes a seat frame 15, a seat cushion 16, and a seat cover 17 that defines an external surface thereof. The seat back 14 may, however, be alternatively configured or include any structural components if so desired. The illustrated seat frame 15 can be a metal frame that is, in large measure, conventional in the art. For example, the seat frame 15 can be a metal structure having cross members being formed using a stamping or machining process. Alternatively, the seat frame 15 may be a molded frame. For example, the seat frame 15 can be a plastic frame having a plurality of cross members formed using an injection molding process or any other forming process. It should be appreciated that the seat frame 15 can be any structure for a desired application. The seat cushion 16 and the seat cover 17 are also, in large measure, conventional in the art and can be formed from any suitable material or combination of materials for seating applications.

As briefly described above, the illustrated head restraint 18 is supported on the seat back 14 by the pair of support members 19a, 19b. To accomplish this, the illustrated seat frame 15 has first and second openings that are configured to respectively receive the support members 19a, 19b of the head restraint 18. The openings may extend through the seat cushion 16 and the seat cover 17. A slot 15a (only one is shown in FIG. 3) can be formed by any number of cross members or other support structures of the seat frame 15. Thus, as shown, the support member 19a is disposed within the slot 15a and extends upwardly from the seat back 14 through the opening. The support member 19a can be mounted for sliding movement within the slot 15a such that the head restraint 18 is adjustable relative to the seat back 14, although such is not required. Alternatively (or in addition), a pair of guide sleeves (not shown) or the like may be provided on the seat frame 15 to receive the support members 19a and 19b. It should become apparent that the guide sleeves can also be integrated with any portion of the release mechanism 20 if so desired.

The support member 19a is configured to extend from the seat frame 15 through the opening that is defined in the seat cushion 16 and the seat cover 17. In the illustrated embodiment, a portion of the release mechanism 20 also extends through the same opening formed in the seat cushion 16 and the seat cover 17. To accomplish this, the release mechanism 20 is mounted to the seat frame 15 and axially aligned with the support member 19a. The support member 19a fully extends through an aperture formed in the release mechanism 20 such that a release lever 80 of the release mechanism 20 is rotatable about the support member 19a, as will be explained below.

The release mechanism 20 can be mounted to the seat frame 15 in any manner. For example, the illustrated release mechanism 20 is positioned between spaced cross members of the molded seat frame 15. It should also be appreciated that portions of the release mechanism 20 can be formed as part of the seat frame 15 or otherwise integrated therewith, although such is not required. If a metal seat frame is used, as explained above, the release mechanism 20 can be mounted or otherwise secured to a cross member or other structural component using fasteners or the like.

Referring now to FIGS. 3 and 4, the illustrated release mechanism 20 includes a housing 30. As will be explained below, the housing 30 is configured to support a disk 40 for rotation relative thereto. The linkage 50 is mounted to the housing 30. A cover 60 is attached to a bottom of the housing 30 for securing the disk 40 therein, although such is not required. A cap 70 is optionally secured to a top of the housing 30 for concealing the opening in the seat cover 17 of the seat back 14. The release lever 80 is secured to the disk 40 for rotation therewith and extends outwardly through the cap 70. It should be appreciated, however, that the release mechanism 20 is not limited to the illustrated embodiment, but may include any number of components or define any structure as desired.

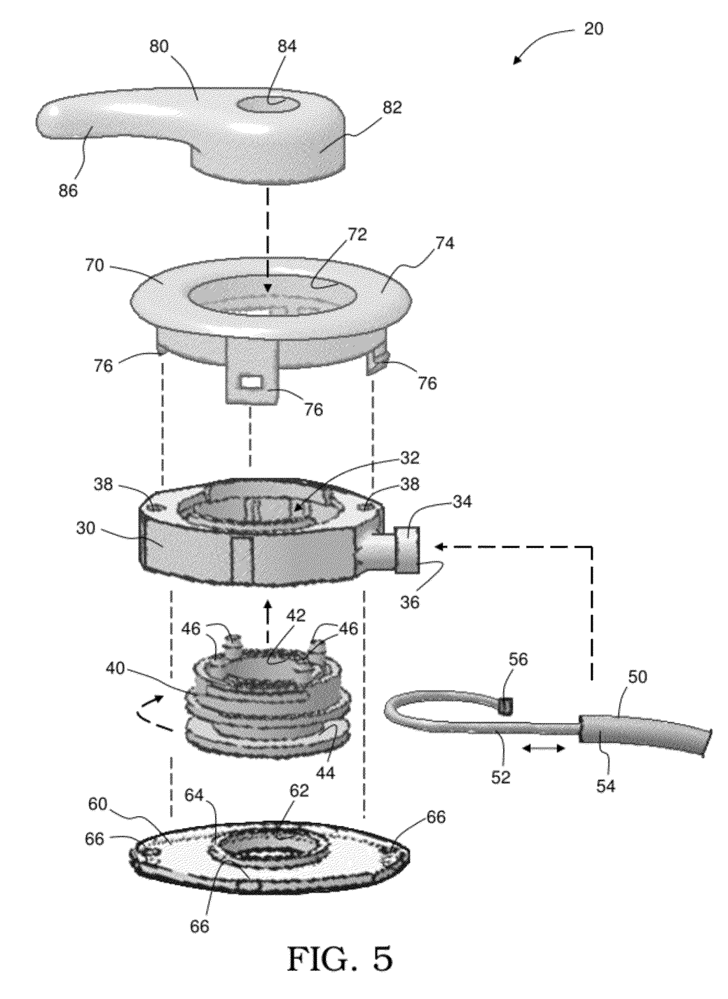

Referring now to FIG. 5, the individual components of the release mechanism 20 are illustrated in an unassembled position. As shown, the housing 30 is a generally cylindrical member having an internal region, indicated generally at 32, provided therein. The housing 30 is configured to receive and support the disk 40 for rotation within the internal region 32. For example, the internal region 32 may have an inner diameter that corresponds with an outer diameter of the disk 40. In other embodiments, the housing 30 may include a bearing element or the like if so desired. It should be appreciated that the housing 30 can be any structure that is adapted to support and facilitate rotation of the disk 40.

The illustrated housing 30 also includes a coupling structure 34 that extends outwardly from a side thereof, although such is not required. The coupling structure 34 is configured to engage a portion of the linkage 50 and secure it to the housing 30, as will be explained below. Thus, the coupling structure 34 can be an annular piece having an inner diameter that is configured to receive a portion of the linkage 50. The coupling structure 34 may also define an aperture 36 that provides communication from the exterior of the housing 30 to the internal region 32 thereof for a purpose that will be explained below. Alternatively, the coupling structure 34 may be any other structure for a desired purpose.

As briefly described above, the release mechanism 20 may be mounted to the seat frame 15. Thus, the housing 30 can have any external shape so as to correspond in mating fashion with the cross members of the seat frame 15, although such is not required. The housing 30 may also include one or more threaded apertures 38 or any other mounting features, such as alignment pins or the like. Alternatively, the housing 30 can be integrally formed as part of the seat frame 15 if so desired.

The illustrated disk 40 is a generally cylindrical member having an aperture 42 that axially extends therethrough. As briefly explained above, the disk 40 is configured to be supported for rotation relative to the housing 30. To accomplish this, the disk 40 can be disposed within the internal region 32 of the housing 30 such that an outer surface of the disk 40 slides along an inner surface of the housing 30. It should be appreciated that the disk 40 can have any structural features or rotatable elements to facilitate rotation within the housing 30.

The illustrated disk 40 also defines a groove 44 that extends around the outer surface thereof, although such is not required. The groove 44 may extend either fully or partially around the disk 40. The purpose of the groove 44 will be explained below. The disk 40 may optionally include one or more support posts 46. The support posts 46 are configured to secure the release lever 80 to the disk 40 for rotation as a unit. As such, the illustrated support posts 46 extend from a top surface of the disk 40 for engagement with the release lever 80. The support posts 46 may include any internal or external fastening features for securing the release lever 80 to the disk 40.

As shown in FIG. 2, a first end of the linkage 50 is attached to the release mechanism 20 and a second end of the linkage 50 is attached to the reclining mechanism 13 for operation thereof. Thus, the illustrated linkage 50 can be a flexible cable that is, in large measure, conventional in the art and commonly referred to in the automotive seat industry as a Bowden cable. As shown in FIG. 5, the linkage 50 includes an inner cable 52 that is movably disposed within an outer sheath 54, although the outer sheath 54 is not required. In other embodiments, the linkage 50 can be a wire, rope, chain, synthetic line, or the like.

The inner cable 52 may include a fastener 56 secured to a first end thereof. The fastener 56 is configured to attach a first end of the inner cable 52 to the disk 40. For example, the fastener 56 can be an oversized end portion or nipple that is adapted to be received within a slot or the like defined by the disk 40. Alternatively, the fastener 56 can include a clasp, a threaded portion, or any other feature. Although not shown, the second end of the inner cable 52 may also include a fastening member or the like for attachment to the reclining mechanism 13.

As shown in FIGS. 3 and 4, the first end of the outer sheath 54 is configured to be received within the coupling structure 34 of the housing 30. The outer sheath 54 can be secured therein by a press-fit connection, an adhesive, a threaded connection, or the like. Thus, it should be appreciated that the linkage 50 can be secured to the housing 30 in any manner.

Referring back to FIG. 5, the illustrated cover 60 is a generally flat member having an aperture 62 that extends therethrough. The cover 60 is configured to rotatably support the disk 40 within the internal region 32 of the housing 30. As such, the cover 60 is secured to a bottom of the housing 30 and can be generally shaped to correspond with the housing 30 if so desired. The cover 60 may also include an inner flange 64 that frames the aperture 62 thereof, although such is not required. The inner flange 64 is adapted to extend into the aperture 42 of the disk 40 so as to facilitate rotation of the disk 40 within the housing 30. The cover 60 may also include a plurality of holes 66 extending therethrough that are configured to receive fasteners or the like (not shown) for securing the cover 60 to the housing 30.

The illustrated cap 70 is a generally cylindrical member having an aperture 72 that axially extends therethrough. The cap 70 may also include a flange portion 74. The flange portion 74 can extend outwardly from the cap 70 so as to cover or otherwise conceal the opening in the seat cover 17 through which the support member 19a extends. Thus, the flange portion 74 may optionally engage an outer surface of the seat cover 17 when the release mechanism 20 is fully assembled and mounted on the seat assembly 10 (see FIG. 2). It should also be appreciated that the flange portion 74 can be integrally formed with the release lever 80 if so desired.

The illustrated cap 70 also includes a plurality of tabs 76 that axially extend in an axial direction. The tabs 76 are configured to secure the cap 70 to the housing 30. For example, the tabs 76 can be resilient members that are adapted to engage an outer surface of the housing 30 when the cap 70 is placed over the housing 30. Alternatively, the cap 70 can be secured to the housing 30 in any manner, such as by using an adhesive or a threaded connection for example. The cap 70 can have any shape or structural features for a desired application.

The illustrated release lever 80 includes a body portion 82. The body portion 82 is a generally cylindrical member having an aperture 84 that axially extends therethrough. A handle portion 86 extends from the body portion 82 to enable a passenger to manually rotate the release lever 80. The handle portion 86 can have a curvature or any other desired shape to facilitate rotation of the release lever 80. The release lever 80 can be configured in any manner for a desired application.

The assembly of the release mechanism 20 will now be explained. The first end of the inner cable 52 is inserted into the housing 30 through the aperture 36 of the coupling structure 34. A length of the inner cable 52 is wrapped around the disk 40 and positioned within the groove 44. The fastener 56 of the inner cable 52 is then secured to the disk 40. The outer sheath 54 of the cable is secured to the coupling structure 34 of the housing 30. The disk 40 is then inserted into the internal region 32 through the bottom of the housing 30. Subsequently, the cover 60 can be secured to the bottom of the housing 30 for supporting the disk 40 therein. The cap 70 is optionally secured to the top of the housing 30. After the cap 70 is secured to the housing 30, the body portion 82 of the release lever 80 is inserted through the aperture 72 in the cap 70 and secured to the disk 40 for rotation as a unit.

It should be appreciated that the housing 30, the disk 40, the linkage 50, and the cover 60 can be initially assembled and then mounted to the seat frame 15. Other components of the seat back 14 such as the seat cushion 16 and the seat cover 17 can then be attached to the seat frame 15. Subsequently, the cap 70 and the release lever 80 can be secured to their respective components of the release mechanism 20. Once the release mechanism 20 is fully assembled and mounted to the seat back 14, the support member 19a of the head restraint 18 can be inserted through the release mechanism 20 (see FIGS. 2 and 3).

When a passenger desires to pivot the seat back 14, the release lever 80 can be manually rotated about the support member 19a. Rotation of the release lever 80, in turn, rotates the disk 40 within the housing 30. As the disk 40 is rotated, the inner cable 52 becomes coiled or otherwise wrapped around the disk 40 thereby shortening the length of the inner cable 52. The second end of the inner cable 52 is attached to the reclining mechanism 13, which is operable by movement of the inner cable 52. Thus, the illustrated release mechanism 20 is adapted to operate the reclining mechanism 13 for pivotal movement of the seat back 14.

In the illustrated embodiment, the release mechanism 20 extends from an opening in the external surface of the seat back 14 through which the support member 19a of the head restraint 18 also extends. However, it should be appreciated that the release mechanism 20 can extend from any opening in the seat back 14 through which any other support member also extends. Further, the release mechanism 20 can be supported for rotation about any structure of the seat assembly 10 that extends outwardly therefrom, including an arm rest or the like.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A seat assembly comprising:
a seat bottom;
a seat back that is supported for movement relative to the seat bottom;
a support member that extends from the seat back; and
a release mechanism that is supported on the seat back for rotation about the support member, wherein rotation of the release mechanism is adapted to release the seat back for movement relative to the seat bottom.

2. The seat assembly of claim 1, wherein the support member supports a head restraint relative to the seat back.

3. The seat assembly of claim 1, wherein the support member is mounted for movement relative to the seat back.

4. The seat assembly of claim 1, wherein the support member extends through an opening that is formed in an external surface of the seat back.

5. The seat assembly of claim 4, wherein a portion of the release mechanism extends through the opening that is formed in the seat back for the support member.

6. The seat assembly of claim 1, wherein the release mechanism includes an aperture extending therethrough and the support member extends through the aperture.

7. The seat assembly of claim 1, wherein the seat back includes a seat frame disposed within an internal region thereof and the release mechanism is supported for rotation on the seat frame.

8. The seat assembly of claim 1, wherein the release mechanism includes a disk that is supported for rotation about the support member.

9. The seat assembly of claim 8, wherein the disk includes an aperture extending therethrough and the support member extends through the aperture.

10. The seat assembly of claim 8, wherein the release mechanism includes a housing that is supported on the seat back and the disk is supported for rotation within the housing.

11. The seat assembly of claim 8, wherein the release mechanism further includes a release lever that extends from the disk for rotation relative to the support member.

12. The seat assembly of claim 11, wherein the support member extends through an opening that is formed in an external surface of the seat back, and the disk is disposed within an internal region of the seat back such that a portion of the lever extends through the opening.

13. A seat assembly comprising:
a seat bottom;
a seat back that is supported for movement relative to the seat bottom;
a support member that extends from the seat back through an opening formed in an external surface of the seat back; and
a release mechanism that is supported on the seat back, the release mechanism including a housing that is disposed within an internal region of the seat back, a disk that is supported within the housing for rotation about the support member, and a release lever that extends from the disk through the opening formed in the external surface of the seat back, wherein rotation of the release lever is adapted to release the seat back for movement relative to the seat bottom.

14. A seat assembly comprising:
a seat bottom;
a seat back that is supported for movement relative to the seat bottom;
a reclining mechanism that is disposed between the seat bottom and the seat back to facilitate movement of the seat back relative to the seat bottom a support member that extends from the seat back;
a release mechanism that is supported on the seat back for rotation about the support member; and
a linkage that extends from the release mechanism to the reclining mechanism, wherein rotation of the release mechanism is adapted to operate the reclining mechanism.

15. The seat assembly of claim 14, wherein the support member extends through an opening formed in an external surface of the seat back, and a portion of the release mechanism extends through the opening.
